(19) United States
(12) Patent Application Publication
(10) Pub. No.: US 2009/0214734 A1
(43) Pub. Date: Aug. 27, 2009

(54) Method of Extracting Residual Pesticides and Extraction Kit

(75) Inventors: Masahiko Kitayama, Bloomington, IN (US); Masaki Kozono, Ibaraki (JP); Takashi Ohmori, Ibaraki (JP)

Correspondence Address: BIRCH STEWART KOLASCH & BIRCH, PO BOX 747, FALLS CHURCH, VA, 22040-0747, US

(73) Assignee: Nippon Meat Packers, Inc., Osaka-shi (JP)

(21) Appl. No.: 11/885,515

(22) PCT Filed: Mar. 3, 2006
(86) PCT No.: PCT/JP06/04682

§ 371 Date: May 30, 2008

(30) Foreign Application Priority Data
Mar. 4, 2005 (JP) 2005-060563

(51) Int. Cl. A23L 1/015

(52) U.S. Cl. 426/424; 426/431; 426/429

(57) ABSTRACT

A method of extracting residual pesticides in an agricultural product and a kit to be used therein. Namely, a method of extracting residual pesticides which comprises: (1) a step of processing an agricultural product into a form allowing the extraction of the residual pesticides; (2) a step of treating the thus processed agricultural product with a dehydrating agent; and (3) a step of extracting the residual pesticides from the thus dehydrated agricultural product by using a hydrophobic solvent, which has an octanol/water partition coefficient (logPow) of from 0 to 4, or a mixed solvent of hydrophobic solvent and hydrophobic solvent. A kit to be used in the method as described above. By using the above method and kit, the procedure can be simplified and an effect of reducing the amount of extracted contaminants such as pigments can be established.

### TECHNICAL FIELD

The present invention relates to a method of extracting residual pesticides and an extraction kit. More particularly, it relates to a method of extracting pesticides remaining in agricultural products easily and efficiently, and an extraction kit used therein.

### BACKGROUND ART

Hitherto, various pesticides have been used in order to improve the productivity of agricultural products. Recently, the concern is mounting about residual pesticides in food, and importance is attached to measurement of residual pesticides. In this background, the government of Japan is preparing for setting up a standard about residual substances in agricultural products (for example, Notice of Department of Food Safety of Pharmaceutical and Food Bureau of Ministry of Welfare and Labor (Japan) in Director Notice No. 0124001, Appendix “Analytical Methods for Residual Compositional Substances of Agricultural Chemicals, Feed Additives and Veterinary Drugs in Food”).

The conventional method is intended to measure a small number of residual substances, and was not suited to measurement of a large number of residual substances. Since various agents are used as pesticides, a method for measuring multiple pesticides at the same time is demanded in order to measure them easily and quickly (see, for example, Journal of the Food Hygienic Society of Japan, 44, (5), 234-245 (2003), “An Experimental Proficiency Test for Ability to Screen 104 Residual Pesticides in Agricultural Products”).

Specifically, the conventional measuring method of residual pesticides takes much time (about 6 hours), cost and labor (about 30 steps), and a simple method and its kit are demanded. Also, in measurement of vegetables and fruits which contain much water, since a hydrophilic solvent such as acetonitrile and acetone is used as an extraction solvent, contaminants such as pigments etc. which are not target components are also extracted, therefore it takes much time in removing contaminants. Even spend time and effort on removing contaminants, the remaining contaminants may cause noise in measurement.

On the other hand, most pesticides are low in polarity and are not suited for extraction by hydrophilic solvents. In the conventional method, when agricultural products are sulfur containing products such as onion and cabbage, the extract becomes acidic due to sulfate ion produced from sulfur. Some of the pesticides are destroyed in an acidic condition, therefore an adjustment of pH is needed. More over, when agricultural products are fat containing products such as soybean, a process for removing fat is needed, or GPC and other expensive apparatus are needed.

### DISCLOSURE OF THE INVENTION

Thus, in the conventional measuring method of residual pesticides, since the process for extracting residual pesticides from agricultural products (namely, pretreatment process) has a long process, is complicated and requires a long time, the measurement involves many problems.

The present inventors searched for simple pretreatment method (namely, extracting method of residual pesticides), and found that residual pesticides can be extracted easily and efficiently by using an extraction solvent completely different from the conventional extraction solvent, and treating the agricultural products by a special pretreatment agent.

More specifically, the inventors investigated for 1) extraction solvent capable of extracting intended pesticides efficiently, and not extracting contaminants, and 2) proper combination with the pretreatment agent and solvent.

To study the firs point 1), chemical properties of pesticides were examined. Specifically, as the index of polarity of compounds, octanol/water partition coefficient (called logPow herein) was investigated. The index logPow is widely used for expressing the degree of hydrophobic property of substance (as for logPow, see, for example, database of pharmaceutical information research in the homepage of Japan National Institute of Health and Science).

Most pesticides range from 2 to 7 of logPow. To dissolve these pesticides widely and efficiently, a solvent having polarity of about 3 to 4 of logPow is desired. On the other hand, there are pesticides having logPow of about 1 such as Dichlorvos, and having logPow lower than 0 such as Acephate and Methamidophos. To dissolve these pesticides at the same time, a solvent of higher polarity is needed.

Accordingly, by using a hydrophobic solvent of polarity of about 0 to 4 of logPow, or a mixed solvent of hydrophobic solvent and hydrophilic solvent, it was attempted to extract pesticides in samples treated with a dehydrating agent, and it was found that the extraction amount of contaminants such as pigments was extremely lowered. The mixed solvent is comprises mainly a hydrophobic solvent, preferably n-hexane (logPow: 3.9) and a proper amount of a hydrophilic solvent of logPow of about −1.0 to 0, preferably acetone (logPow: −0.24) is added thereto.

Concerning the above-mentioned 2), since the mixed solvent is mainly composed of the hydrophobic solvent, there is a problem in permeability into vegetable and other products containing much water. This problem is solved by pre-treating the agricultural products with a dehydrating agent such as diatom earth (i.e. dehydrating process). As a result, a hydrophobic solvent of low polarity such as n-hexane that could not be used in conventional methods can be used in the extracting process.

The invention is based on these findings, and it is hence an object of the invention to present a method of extracting residual pesticides easily and efficiently from agricultural products, and an extraction kit used therein.

The invention devised to solve the problems mentioned above is a method of extracting residual pesticides in agricultural products comprising the following steps:

(1) a step of processing agricultural products into a shape suitable for extraction of residual pesticides;

(2) a step of treating the processed agricultural products with a dehydrating agent; and

(3) a step of extracting residual pesticides from the dehydrated agricultural products, by using a hydrophobic solvent of logPow of 0 to 4, or a mixed solvent of hydrophobic solvent and hydrophilic solvent.

The mixed solvent of hydrophobic solvent and hydrophilic solvent is preferably an n-hexane-acetone mixed solvent, and further simultaneously with or after the process of treating with the dehydrating agent, it is more preferred to treat with active carbon and/or carrier for reversed-phase chromatography.

The extraction kit of the invention is a kit used in this method, and is composed of a pretreatment agent mainly comprising a dehydrating agent, and an extraction solvent of hydrophobic solvent of logPow of 0 to 4, or a mixed solvent of hydrophobic solvent and hydrophilic solvent. The mixed solvent of hydrophobic solvent and hydrophilic solvent is preferably an n-hexane-acetone mixed solvent, and further the pretreatment agent is preferred to contain the dehydrating agent and at least one of active carbon and carrier for reversed-phase chromatography.

### BEST MODE FOR CARRYING OUT THE INVENTION

The method of the invention is a method of extracting residual pesticides comprising the above steps.

In the method of the invention, first, the agricultural products are processed into a shape suitable for extraction of residual pesticides. This process is carried out in various methods depending on the type of agricultural product. For example, vegetables and fruits are cut into small pieces, and beans and cereals are ground to powder. Depending on the shape of agricultural product, it is processed into a shape so as to be higher in efficiency of extraction of residual pesticides.

The processed agricultural product (i.e. agricultural product sample) is subjected to a dehydrating process. In the method of the invention, as described above, the extraction solvent is a solvent mainly composed of hydrophobic solvent, and if the water content of agricultural product sample is too high, affinity for the solvent is insufficient. Therefore, the water content of agricultural product sample is lowered by using the dehydrating agent.

The dehydrating agent is not particularly specified and includes, for example, diatom earth, molecular sieve, silica gel, sodium sulfate anhydride and magnesium sulfate anhydride.

The amount of dehydrating agent may be properly adjusted depending on the water content of agricultural product sample, or dehydrating capability of the dehydrating agent, and it is usually about 0.5 to 3 times (by weight) of the agricultural product sample.

The dehydrated agricultural product sample is subjected to the extraction process by use of the hydrophobic solvent of logPow of 0 to 4, or the mixed solvent of hydrophobic solvent and hydrophilic solvent.

In this process, the hydrophobic solvent of logPow of 0 to 4 is not particularly specified as far as logPow is in this range, and examples of the solvent may include n-hexane (logPow: 3.9), ethyl acetate (logPow: 0.73), dichloromethane (logPow: 1.25), benzene (logPow: 2.13), toluene (logPow: 2.69) and carbon tetrachloride (logPow: 2.64), which can be used alone or in combination of two or more types.

The extraction solvent may be also the mixed solvent of hydrophobic solvent and hydrophilic solvent, and the hydrophobic solvent includes octane (logPow 5.0) besides the solvents exemplified above.

The hydrophilic solvent includes conventional solvents such as acetone (logPow: −0.24), methanol (logPow: −0.82), ethanol (logPow: −0.32) and acetonitrile (logPow: −0.3).

As to the mixed solvent of hydrophobic solvent and hydrophilic solvent, the mixing ratio of hydrophobic solvent and hydrophilic solvent is not particularly specified, but the mixing ratio of hydrophobic solvent:hydrophilic solvent=95 to 30:5 to 70 (by volume, same hereinafter in mixing ratio of solvent), preferably 80 to 45:20 to 55, and more preferably 50:50 is used. If the ratio of hydrophilic solvent is excessive, the extraction amount of contaminants such as pigments increases, and if less than the specified range, the extraction amount of residual pesticides may decrease.

Among examples of hydrophobic solvent and hydrophilic solvent, in consideration of toxicity, boiling point, melting point and price of solvents, n-hexane is preferred as the hydrophobic solvent, and acetone is preferred as the hydrophilic solvent. Therefore, a preferred example of the mixed solvent of hydrophobic solvent and hydrophilic solvent is a mixed solvent of n-hexane and acetone.

In the extraction process, the extraction solvent and agricultural product sample are mixed in a proper method, for example, mixing by use of a homogenizer. At this time, a proper dehydrating agent may be also added the mixture.

The extraction time can be properly adjusted depending on the type of agricultural product sample and mixing means, when the homogenizer is used, the mixing time is about 1 to 10 minutes, usually about 2 to 5 minutes.

In this method of in the invention, if pigment or other undesired component is extracted, the extraction solution may be treated with active carbon. Also, when the agricultural product is fatty product such as soybean, the extraction solution may be subjected to a defatting process by using carrier for reversed phase chromatography (for example, C₁₈ carrier, C₈ carrier). By such operation, the content of contaminants such as pigments and the fat content in the extraction solution are extremely decreased. Therefore, at the time of analysis by apparatus, the pretreatment of sample to be analyzed can be simplified and noise in measurement can be suppressed.

Such active carbon treatment and defatting process can also be carried out in the dehydrating process and/or extraction process.

After the extraction process, the extraction solution is separated by conventional means such as filtration and centrifugation. The separated extraction solution is evaporated and the residue is re-dissolved in a solvent as required. Then, the residual pesticides are analyzed and determined by conventional analysis equipment or means such as GC/MS.

According to the method of the invention, labor of removing contaminants such as pigments can be saved, and noise-free measurement data can be obtained while curtailing the time (from about 6 hours to about 1 hour), the cost, and the labor (from about 30 steps to about 10 steps). Since the moisture of the agricultural products is removed, drop of pH of the extraction solution due to formation of sulfate ion does not occur. Accordingly, unlike the conventional method, the adjustment of pH of the extraction solution is not needed when the agricultural products containing sulfur components such as onion and cabbage are measured.

Thus, in measurement of residual pesticides in agricultural products, as compared with the conventional method, data of less noise can be obtained more easily, in a shorter time, and by using a smaller amount of organic solvent.

The extraction kit for measuring residual pesticides of the invention is a kit used in such method, and is composed of a pretreatment agent mainly comprising a dehydrating agent, and an extraction agent comprising a hydrophobic solvent of logPow of 0 to 4, or a mixed solvent of hydrophobic solvent and hydrophilic solvent.

The dehydrating agent to be contained in the pretreatment agent includes the dehydrating agent exemplified before, and the extraction agent of the hydrophobic solvent of logPow of 0 to 4, or the mixed solvent of hydrophobic solvent and hydrophilic solvent also includes the solvent exemplified before.

The pretreatment agent may contain, together with the dehydrating agent, at least one of the active carbon and carrier for reversed phase chromatography which have functions to remove pigments and fat component, respectively.

The extraction kit of the invention may be used according to the extraction method of the invention described above.

The agricultural products to be measured in the invention are not particularly specified as far as measurement of residual pesticides is needed, and examples include vegetables (for example. spinach, onion, Chinese cabbage, cabbage, cucumber, eggplant, tomato), fruits (for example. persimmon, apple, pear, orange), beans (for example. soybean, adzuki bean, broad bean, cow-pea), seeds (for example. sesame, chestnut, peanut), cereals (for example. rice, wheat, barley, rye, corn) and potatoes (for example. potato, sweet potato, taro, Chinese yam).

The pesticides to be extracted include all pesticides used in the agricultural field.

### INDUSTRIAL APPLICABILITY

According to the method and kit of the invention, since a solvent mainly composed of hydrophobic solvent is used as the extraction solvent, extraction amount of contaminants such as pigments is decreased. Therefore, the operation is simplified and the precision of measurement is enhanced. Further, since the agricultural products are treated with the dehydrating agent, production of sulfate ion from agricultural products containing sulfur can be suppressed, and therefore pesticides unstable in acidic condition can be measured.

### EXAMPLES

The invention is more specifically described below by referring to Comparative Examples and Examples, but the invention is not limited to these Examples alone. In Examples, the numerals in parentheses refer to the number of steps in each process.

### Comparative Example 1

### Conventional Method 1

From whole spinach, fibrous roots and denatured leaves were removed (1), and the remaining spinach was cut and homogenized by a food processor (2). A portion of 20 g was weighed (3), 50 ml of acetonitrile was added thereto (4), and the mixture was homogenized for 3 minutes at 10000 rpm (5). After filtration in vacuo (6), 20 ml of acetonitrile was added to the residue (7), and the mixture was homogenized again (8), and filtered in vacuo (9). Two filtrates were combined (10), and acetonitrile was added to make up 100 ml (11). A portion of 20 ml was poured into a separating funnel (12), and 10 g of sodium chloride (13) and 20 ml of 0.5M phosphate buffer (pH 7.0) were added (14), and the mixture was shaken for 10 minutes (15). The acetonitrile layer was separated (16), and the solution was dehydrated by adding sodium sulfate anhydride (17), and filtered (18). The resultant solution was condensed in vacuo at 35° C. (19). Condensation in vacuo was stopped immediately before caking, and the residue was dried under nitrogen stream (20). The caked residue was dissolved in 2 ml of toluene-acetonitrile mixed solution (1:3) (21), and an extract was obtained. A solid phase extraction column of ENVI-Carv/LC-NH₂ (6 ml, 500 mg/500 mg) was conditioned in 10 ml of toluene-acetonitrile mixed solution (1:3) (22), and the extract was loaded (23). In a flow of 20 ml of toluene-acetonitrile mixed solution (1:3), the eluate from the column was collected (24), and condensed in vacuo at 35° C. to be condensed to 1 ml or less (25). After adding 10 ml of acetone to the condensed product, it was further condensed to 1 ml or less (26), and 5 ml of acetone was added, and it was condensed again (27). Condensation in vacuo was stopped immediately before caking, and the residue was dried under nitrogen stream (28). The residue was dissolved in 2 ml of acetone-n-hexane mixed solution (1:1) (29) to obtain a test solution. The test solution was transferred into a sample vial (30) and presented for analysis by GC/MS (31).

### Comparative Example 2

### Conventional Method 2

After grinding soybean (1), a portion of 10 g was weighed (2), 20 ml of water was added thereto and allowed to stand for 15 minutes (3). To the mixture, 50 ml of acetonitrile was added (4), and the mixture was homogenized for 3 minutes at 10000 rpm (5). After filtration in vacuo (6), 20 ml of acetonitrile was added to the residue (7), and the mixture was homogenized again (8), and filtered in vacuo (9). Two filtrates were combined (10), and acetonitrile was added to make up 100 ml (11). A portion of 20 ml was poured into a separating funnel (12), and 10 g of sodium chloride (13) and 20 ml of 0.5M phosphate buffer (pH 7.0) were added (14). The mixture was shaken for 10 minutes (15), and the acetonitrile layer was separated (16). A solid phase extraction column of Bond Elut C₁₈ (6 ml, 1 g) was conditioned in 10 ml acetonitrile (17), and the separated acetonitrile was loaded (18). To the column, 2 ml of acetonitrile was added to elute (19). The eluate was dehydrated by adding sodium sulfate anhydride (20), and filtered (21). The solution was condensed in vacuo at 35° C. (22). Condensation in vacuo was stopped immediately before caking, and the residue was dried under nitrogen stream (23). The residue was dissolved in 2 ml of toluene-acetonitrile mixed solution (1:3) (24), and an extract was obtained. A solid phase extraction column of ENVI-Carv/LC-NH₂ (6 ml, 500 mg/500 mg) was conditioned in 10 ml of toluene-acetonitrile mixed solution (1:3) (25), and the extract was loaded (26). In a flow of 20 ml of toluene-acetonitrile mixed solution (1:3), the eluate from the column was collected (27), and condensed in vacuo at 35° C. to be condensed to 1 ml or less (28). After adding 10 ml of acetone to the condensed product, it was further condensed to 1 ml or less (29), and 5 ml of acetone was added, and it was condensed again (30). Condensation in vacuo was stopped immediately before caking, and the residue was dried under nitrogen stream (31). The residue was dissolved in 2 ml of acetone-n-hexane mixed solution (1:1) (32) to obtain a test solution. The test solution was transferred into a sample vial (33), and presented for analysis by GC/MS (34).

### Example 1

### Method 1 of the Invention

From whole spinach, fibrous roots and denatured leaves were removed (1), and the remaining spinach was cut and homogenized by a food processor (2). A portion of 2 g was weighed (3) and mixed well with a pretreatment agent (i.e. 2 g of diatom earth, 0.3 g of active carbon) (4). Then, 25 ml of an extraction solvent (i.e. n-hexane:acetone=1:1) (5) and 5 g of sodium sulfate anhydride were added thereto (6), and the mixture was homogenized for 3 minutes at 10000 rpm (7). By centrifugal separation for 10 minutes at 5000 rpm, a supernatant was obtained (8). The supernatant was evaporated in vacuo at 35° C. (9), and the reside was dissolved in 2 ml of acetone (10). The solution was transferred into a sample vial (11), and presented for analysis by GC/MS (12).

### Example 2

### Method 2 of the Invention

After grinding soybean (1), a portion of 2 g was weighed (2) and mixed well with a pretreatment agent (i.e. 2 g of diatom earth, 2 g of C₁₈ reversed phase beads, 0.3 g of active carbon) (3). Then, 25 ml of an extraction solvent (i.e. n-hexane:acetone=1:1) (4) and 5 g of sodium sulfate anhydride were added thereto (5), and the mixture was homogenized for 3 minutes at 10000 rpm (6). By centrifugal separation for 10 minutes at 5000 rpm, a supernatant was obtained (7). The supernatant was evaporated in vacuo at 35° C. (8) and the residue was dissolved in 2 ml of acetone (9). The solution was transferred into a sample vial (10), and presented for analysis by GC/MS (11).

The number of processes (steps) and duration (minutes) required in the conventional methods 1 and 2 and methods 1 and 2 of the invention are as follows.

| | |
|---|---|
| Conventional method 1 | 31 steps, 310 minutes |
| Conventional method 2 | 34 steps, 340 minutes |
| Method 1 of the invention | 12 steps, 64 minutes |
| Method 2 of the invention | 11 steps, 59 minutes |

In the conventional methods 1 and 2 and methods 1 and 2 of the invention, recovery tests were conducted by adding 100 ppb of pesticides to agricultural products. Results are shown in Tables 1 to 4. Tables 1 and 2 relate to results (recovery rate %) of methods 1 and 2 of the invention, and Tables 3 and 4 relate to results of conventional methods 1 and 2.

TABLE 1
(Method 1 of the invention)

Recovery rate

Pyrethroid compounds

| | |
|---|---|
| Acrinathrin | 94.8 |
| Cyhalothrin 01 | 98.9 |
| Cyhalothrin 02 | 100.4 |
| Cyfluthrin 01 | 98.0 |
| Cyfluthrin 02 | 92.0 |
| Cyfluthrin 03 | 100.7 |
| Cyfluthrin 04 | 98.4 |
| Cypermethrin | 93.2 |
| Cypermethrin 02 | 97.1 |
| Cypermethrin 03 | 98.0 |
| Cypermethrin 04 | 91.3 |
| Tefluthrin | 96.1 |
| Deltamethrin | 98.2 |
| Fenvalerate | 98.3 |
| Fenvalerate 02 | 88.1 |
| Flucythrinate 01 | 91.9 |
| Flucythrinate 02 | 90.8 |
| Fluvalinate 01 | 88.6 |
| Fluvalinate 02 | 83.5 |
| Permethrin | 96.8 |
| Permethrin 02 | 99.2 |

Organic chlorine compounds

| | |
|---|---|
| α-BHC | 92.1 |
| β-BHC | 94.7 |
| γ-BHC | 97.2 |
| δ-BHC | 103.1 |
| p.p-DDD | 98.6 |
| p.p-DDE | 96.5 |
| o.p.-DDT | 98.5 |
| p.p-DDT | 99.6 |
| Aldrin | 91.1 |
| Dieldrin | 95.3 |
| Endrin | 94.5 |
| Halfenprox | 103.3 |

Nitrogen compounds

| | |
|---|---|
| Isoprocarb | 90.8 |
| Esprocarb | 97.0 |
| Chlorpropham | 105.3 |
| Diethofencarb | 92.3 |
| Cyproconazole 01 | 93.4 |
| Cyproconazole 02 | 92.4 |
| Thiobencarb | 97.6 |
| Thenylchlor | 95.0 |
| Tebuconazole | 95.8 |
| Tebufenpyrad | 100.9 |
| Triadimenol 01 | 90.0 |
| Triadimenol 02 | 88.0 |
| Paclobutrazol | 87.3 |
| Pyriproxyfen | 95.4 |
| Pirimicarb | 88.6 |
| Fenarimol | 88.9 |
| Fenobucarb | 91.0 |
| Pretilachlor | 97.3 |
| Propiconazole 01 | 97.8 |
| Propiconazole 02 | 95.9 |
| Bendiocarb | 95.0 |
| Pendimethalin | 96.0 |
| Myclobutanil | 93.0 |
| Methiocarb 01 | 96.8 |
| Methiocarb 02 | 87.4 |
| Metolachlor | 93.0 |
| Mefenacet | 104.0 |
| Mepronil | 93.9 |
| Lenacil | 85.2 |

Organic phosphorus compounds

| | |
|---|---|
| EPN | 93.2 |
| Acephate | 62.2 |
| Edifenphos | 87.3 |
| Ethoprophos | 92.7 |
| Etrimfos | 91.0 |
| Cadusafos | 95.3 |
| Quinalphos | 95.1 |
| Chlorpyrifos | 92.4 |
| Chlorfenvinphos 01 | 96.9 |
| Chlorfenvinphos 02 | 92.0 |
| Dichlorvos | 49.2 |
| Dimethylvinphos | 87.4 |
| Diazinon | 95.3 |
| Thiometon | 82.9 |
| Terbufos | 92.7 |
| Parathion | 94.6 |
| Parathion-methyl | 100.4 |
| Pyraclofos | 88.5 |
| Pirimiphos-methyl | 93.7 |
| Fenitrothion | 95.7 |
| Fensulfothion | 87.8 |
| Fenthion | 91.9 |
| Phenthoate | 97.5 |
| Prothiofos | 97.3 |
| Phosalone | 82.4 |
| Fosthiazate 01 | 87.0 |
| Fosthiazate 02 | 87.8 |
| Malathion | 93.8 |
| Methamidophos | 49.3 |

Recovery rate by 100 ppb addition recovery test

TABLE 2
(Method 2 of the invention)

Recovery rate

Pyrethroid compounds

| | |
|---|---|
| Acrinathrin | 92.2 |
| Cyhalothrin 01 | 95.3 |
| Cyhalothrin 02 | 99.9 |
| Cyfluthrin 01 | 90.2 |
| Cyfluthrin 02 | 85.4 |
| Cyfluthrin 03 | 82.3 |
| Cyfluthrin 04 | 96.7 |
| Cypermethrin | 82.6 |
| Cypermethrin 02 | 80.2 |
| Cypermethrin 03 | 84.6 |
| Cypermethrin 04 | 82.2 |
| Tefluthrin | 95.5 |
| Deltamethrin | 93.4 |
| Fenvalerate | 90.2 |
| Fenvalerate 02 | 85.6 |
| Flucythrinate 01 | 90.2 |
| Flucythrinate 02 | 91.0 |
| Fluvalinate 01 | 82.1 |
| Fluvalinate 02 | 80.6 |
| Permethrin | 88.5 |
| Permethrin 02 | 87.9 |

Organic chlorine compounds

| | |
|---|---|
| α-BHC | 91.1 |
| β-BHC | 94.4 |
| γ-BHC | 95.6 |
| δ-BHC | 100.2 |
| p.p-DDD | 85.9 |
| p.p-DDE | 84.3 |
| o.p.-DDT | 98.3 |
| p.p-DDT | 102.3 |
| Aldrin | 80.2 |
| Dieldrin | 83.9 |
| Endrin | 90.2 |
| Halfenprox | 88.6 |

Nitrogen compounds

| | |
|---|---|
| Isoprocarb | 85.4 |
| Esprocarb | 90.2 |
| Chlorpropham | 98.3 |
| Diethofencarb | 80.2 |
| Cyproconazole 01 | 88.7 |
| Cyproconazole 02 | 86.9 |
| Thiobencarb | 95.6 |
| Thenylchlor | 90.5 |
| Tebuconazole | 91.8 |
| Tebufenpyrad | 80.5 |
| Triadimenol 01 | 85.1 |
| Triadimenol 02 | 84.3 |
| Paclobutrazol | 82.5 |
| Pyriproxyfen | 90.5 |
| Pirimicarb | 80.0 |
| Fenarimol | 83.6 |
| Fenobucarb | 93.6 |
| Pretilachlor | 89.7 |
| Propiconazole 01 | 88.8 |
| Propiconazole 02 | 87.2 |
| Bendiocarb | 87.9 |
| Pendimethalin | 90.0 |
| Myclobutanil | 84.3 |
| Methiocarb 01 | 97.2 |
| Methiocarb 02 | 90.3 |
| Metolachlor | 93.1 |
| Mefenacet | 91.0 |
| Mepronil | 87.2 |
| Lenacil | 75.1 |

Organic phosphorus compounds

| | |
|---|---|
| EPN | 84.5 |
| Acephate | 60.1 |
| Edifenphos | 83.1 |
| Ethoprophos | 85.1 |
| Etrimfos | 82.1 |
| Cadusafos | 81.2 |
| Quinalphos | 87.1 |
| Chlorpyrifos | 84.1 |
| Chlorfenvinphos 01 | 89.1 |
| Chlorfenvinphos 02 | 90.5 |
| Dichlorvos | 40.5 |
| Dimethylvinphos | 80.1 |
| Diazinon | 89.1 |
| Thiometon | 80.1 |
| Terbufos | 80.7 |
| Parathion | 89.6 |
| Parathion-methyl | 90.5 |
| Pyraclofos | 83.8 |
| Pirimiphos-methyl | 86.4 |
| Fenitrothion | 84.9 |
| Fensulfothion | 80.6 |
| Fenthion | 92.6 |
| Phenthoate | 94.3 |
| Prothiofos | 81.5 |
| Phosalone | 79.5 |
| Fosthiazate 01 | 81.0 |
| Fosthiazate 02 | 79.8 |
| Malathion | 91.6 |
| Methamidophos | 42.1 |

Recovery rate by 100 ppb addition recovery test

TABLE 3
(Conventional method 1)

Recovery rate

Pyrethroid compounds

| | |
|---|---|
| Acrinathrin | 91.4 |
| Cyhalothrin 01 | 90.6 |
| Cyhalothrin 02 | 92.2 |
| Cyfluthrin 01 | 98.1 |
| Cyfluthrin 02 | 95.2 |
| Cyfluthrin 03 | 94.6 |
| Cyfluthrin 04 | 94.8 |
| Cypermethrin | 95.1 |
| Cypermethrin 02 | 90.3 |
| Cypermethrin 03 | 95.3 |
| Cypermethrin 04 | 85.6 |
| Tefluthrin | 79.5 |
| Deltamethrin | 90.5 |
| Fenvalerate | 85.5 |
| Fenvalerate 02 | 80.3 |
| Flucythrinate 01 | 88.6 |
| Flucythrinate 02 | 87.2 |
| Fluvalinate 01 | 84.8 |
| Fluvalinate 02 | 85.2 |
| Permethrin | 85.6 |
| Permethrin 02 | 85.3 |

Organic chlorine compounds

| | |
|---|---|
| α-BHC | 81.6 |
| β-BHC | 80.3 |
| γ-BHC | 81.2 |
| δ-BHC | 77.5 |
| p.p-DDD | 100.1 |
| p.p-DDE | 85.2 |
| o.p.-DDT | 65.8 |
| p.p-DDT | 55.3 |
| Aldrin | 81.6 |
| Dieldrin | 86.3 |
| Endrin | 90.3 |
| Halfenprox | 94.5 |

Nitrogen compounds

| | |
|---|---|
| Isoprocarb | 87.3 |
| Esprocarb | 85.2 |
| Chlorpropham | 85.3 |
| Diethofencarb | 88.2 |
| Cyproconazole 01 | 88.3 |
| Cyproconazole 02 | 85.1 |
| Thiobencarb | 82.3 |
| Thenylchlor | 98.3 |
| Tebuconazole | 85.2 |
| Tebufenpyrad | 90.9 |
| Triadimenol 01 | 80.8 |
| Triadimenol 02 | 82.1 |
| Paclobutrazol | 85.6 |
| Pyriproxyfen | 90.2 |
| Pirimicarb | 87.2 |
| Fenarimol | 81.2 |
| Fenobucarb | 76.9 |
| Pretilachlor | 93.2 |
| Propiconazole 01 | 85.3 |
| Propiconazole 02 | 87.5 |
| Bendiocarb | 88.7 |
| Pendimethalin | 81.7 |
| Myelobutanil | 85.5 |
| Methiocarb 01 | 90.6 |
| Methiocarb 02 | 89.3 |
| Metolachlor | 90.0 |
| Mefenacet | 103.0 |
| Mepronil | 79.3 |
| Lenacil | 85.2 |

Organic phosphorus compounds

| | |
|---|---|
| EPN | 94.9 |
| Acephate | 56.3 |
| Edifenphos | 85.2 |
| Ethoprophos | 84.2 |
| Etrimfos | 85.5 |
| Cadusafos | 89.8 |
| Quinalphos | 90.7 |
| Chlorpyrifos | 88.6 |
| Chlorfenvinphos 01 | 90.8 |
| Chlorfenvinphos 02 | 92.1 |
| Dichlorvos | 73.4 |
| Dimethylvinphos | 85.2 |
| Diazinon | 87.5 |
| Thiometon | 65.5 |
| Terbufos | 85.8 |
| Parathion | 90.2 |
| Parathion-methyl | 90.3 |
| Pyraclofos | 106.2 |
| Pirimiphos-methyl | 89.1 |
| Fenitrothion | 89.9 |
| Fensulfothion | 85.2 |
| Fenthion | 84.5 |
| Phenthoate | 87.8 |
| Prothiofos | 90.8 |
| Phosalone | 75.8 |
| Fosthiazate 01 | 90.8 |
| Fosthiazate 02 | 88.7 |
| Malathion | 85.5 |
| Methamidophos | 70.6 |

Recovery rate by 100 ppb addition recovery test

TABLE 4
(Conventional method 2)

Recovery rate

Pyrethroid compounds

| | |
|---|---|
| Acrinathrin | 89.6 |
| Cyhalothrin 01 | 91.5 |
| Cyhalothrin 02 | 92.1 |
| Cyfluthrin 01 | 81.6 |
| Cyfluthrin 02 | 80.4 |
| Cyfluthrin 03 | 77.2 |
| Cyfluthrin 04 | 84.9 |
| Cypermethrin | 71.2 |
| Cypermethrin 02 | 73.3 |
| Cypermethrin 03 | 69.3 |
| Cypermethrin 04 | 72.6 |
| Tefluthrin | 80.2 |
| Deltamethrin | 86.2 |
| Fenvalerate | 67.7 |
| Fenvalerate 02 | 68.1 |
| Flucythrinate 01 | 79.5 |
| Flucythrinate 02 | 78.1 |
| Fluvalinate 01 | 74.7 |
| Fluvalinate 02 | 76.0 |
| Permethrin | 60.6 |
| Permethrin 02 | 63.2 |

Organic chlorine compounds

| | |
|---|---|
| α-BHC | 79.8 |
| β-BHC | 80.2 |
| γ-BHC | 78.5 |
| δ-BHC | 86.1 |
| p.p-DDD | 80.9 |
| p.p-DDE | 74.9 |
| o.p.-DDT | 70.3 |
| p.p-DDT | 71.4 |
| Aldrin | 58.8 |
| Dieldrin | 76.6 |
| Endrin | 86.3 |
| Halfenprox | 78.4 |

Nitrogen compounds

| | |
|---|---|
| Isoprocarb | 77.1 |
| Esprocarb | 72.7 |
| Chlorpropham | 75.2 |
| Diethofencarb | 55.3 |
| Cyproconazole 01 | 75.3 |
| Cyproconazole 02 | 70.2 |
| Thiobencarb | 80.3 |
| Thenylchlor | 85.3 |
| Tebuconazole | 80.8 |
| Tebufenpyrad | 63.2 |
| Triadimenol 01 | 71.7 |
| Triadimenol 02 | 70.9 |
| Paclobutrazol | 75.1 |
| Pyriproxyfen | 80.2 |
| Pirimicarb | 65.2 |
| Fenarimol | 75.3 |
| Fenobucarb | 80.6 |
| Pretilachlor | 70.3 |
| Propiconazole 01 | 74.6 |
| Propiconazole 02 | 73.8 |
| Bendiocarb | 77.6 |
| Pendimethalin | 67.9 |
| Myclobutanil | 75.1 |
| Metbiocarb 01 | 94.1 |
| Metbiocarb 02 | 93.7 |
| Metolachlor | 94.2 |
| Mefenacet | 75.8 |
| Mepronil | 70.6 |
| Lenacil | 43.5 |

Organic phosphorus compounds

| | |
|---|---|
| EPN | 80.6 |
| Acephate | 52.1 |
| Edifenphos | 70.2 |
| Ethoprophos | 65.5 |
| Etrimfos | 80.7 |
| Cadusafos | 74.5 |
| Quinalphos | 81.1 |
| Chlorpyrifos | 80.1 |
| Chlorfenvinphos 01 | 85.3 |
| Chlorfenvinphos 02 | 82.5 |
| Dichlorvos | 40.8 |
| Dimethylvinphos | 65.5 |
| Diazinon | 80.1 |
| Thiometon | 65.2 |
| Terbufos | 69.8 |
| Parathion | 80.4 |
| Parathion-methyl | 75.0 |
| Pyraclofos | 91.4 |
| Pirimiphos-methyl | 80.4 |
| Fenitrothion | 79.6 |
| Fensulfothion | 67.3 |
| Fenthion | 86.0 |
| Phenthoate | 84.2 |
| Prothiofos | 74.8 |
| Phosalone | 66.5 |
| Fosthiazate 01 | 67.5 |
| Fosthiazate 02 | 66.8 |
| Malathion | 80.9 |
| Methamidophos | 43.9 |

Recovery rate by 100 ppb addition recovery test

As clear from comparison of Tables 1 to 4, excluding few exceptions, the method of the invention recorded higher recovery rates. The method of the invention has been proved to extract various residual pesticides efficiently.

Next, by varying the mixing ratio of n-hexane and acetone of the extraction solvent, extraction efficiency of various compounds was investigated.

### Example 3

Recovery tests were conducted by adding 100 ppb of pesticides to agricultural products in the same procedure as in method 1 of the invention, except that the extraction solvent was n-hexane:acetone=10:0. Results are shown in Table 5.

### Example 4

Recovery tests were conducted in the same manner as in Example 3, except that the extraction solvent was n-hexane:acetone=7:3. Results are shown in Table 5.

### Example 5

Recovery tests were conducted in the same manner as in Example 3, except that the extraction solvent was n-hexane:acetone=3:7. Results are shown in Table 5.

### Comparative Example 3

Recovery tests were conducted in the same manner as in Example 3, except that the extraction solvent was n-hexane:acetone=0:10. Results are shown in Table 5.

TABLE 5
Recovery rate by 100 ppb addition recovery test

| | Recovery rate | | | |
|---|---|---|---|---|
| | n-hexane:acetone | | | |
| | | | | Comparative |
| | Example 3 | Example 4 | Example 5 | Example 3 |
| Pesticide | (10:0) | (7:3) | (3:7) | (0:10) |

Pyrethroid compounds

| | | | | |
|---|---|---|---|---|
| Acrinathrin | 98.9 | 96.1 | 93.7 | 55.4 |
| Cyhalothrin 01 | 100.1 | 98.1 | 87.5 | 80.2 |
| Cyhalothrin 02 | 98.1 | 97.8 | 85.4 | 79.4 |
| Tefluthrin | 99.5 | 94.2 | 77.1 | 75.3 |
| Fenvalerate | 100.3 | 98.2 | 92.4 | 85.1 |
| Fenvalerate 02 | 94.1 | 95.3 | 90.1 | 84.1 |

Organic chlorine compounds

| | | | | |
|---|---|---|---|---|
| α-BHC | 77.6 | 84.3 | 88.5 | 77.2 |
| β-BHC | 84.3 | 87.1 | 83.1 | 79.1 |
| γ-BHC | 86.2 | 90.4 | 94.2 | 82.7 |
| δ-BHC | 87.6 | 86.7 | 93.1 | 84.1 |
| o.p.-DDT | 103.4 | 100.2 | 79.2 | 64.2 |
| p.p-DDT | 102.5 | 98.1 | 76.4 | 65.1 |
| Aldrin | 78.3 | 84.7 | 75.1 | 72.1 |
| Dieldrin | 95.1 | 92.5 | 89.1 | 85.1 |
| Endrin | 99.4 | 89.9 | 92.4 | 88.1 |

Nitrogen compounds

| | | | | |
|---|---|---|---|---|
| Isoprocarb | 90.5 | 88.4 | 80.5 | 66.4 |
| Ethiofencarb | 28.1 | 40.5 | 73.5 | 50.1 |
| Chlorpropham | 105.4 | 99.9 | 88.2 | 75.8 |
| Thiobencarb | 99.9 | 96.6 | 89.9 | 70.5 |
| Tebuconazole | 69.4 | 81.6 | 91.0 | 89.3 |
| Fenobucarb | 95.1 | 93.7 | 88.5 | 79.8 |
| Bendiocarb | 99.4 | 96.7 | 73.2 | 55.5 |
| Pendimethalin | 98.1 | 96.8 | 88.1 | 76.2 |
| Mepronil | 93.5 | 93.3 | 81.5 | 77.1 |
| Lenacil | 62.4 | 70.4 | 88.8 | 91.0 |

Organic phosphorus compounds

| | | | | |
|---|---|---|---|---|
| Acephate | 0.0 | 8.9 | 57.4 | 58.1 |
| Isofenphosoxon | 30.4 | 55.7 | 72.5 | 69.4 |
| Chlorpyrifos | 92.7 | 93.7 | 86.5 | 70.3 |
| Dichlorvos | 30.1 | 40.5 | 49.2 | 45.2 |
| Diazinon | 83.2 | 85.1 | 80.1 | 68.4 |
| Thiometon | 83.1 | 79.4 | 81.1 | 77.1 |
| Pyraclofos | 52.1 | 71.6 | 92.4 | 95.7 |
| Phosalone | 32.7 | 75.4 | 81.1 | 77.9 |
| Malathion | 96.1 | 93.4 | 88.3 | 84.2 |

As shown in Table 5, when only acetone is used as the extraction solvent, extraction results are not favorable, but when n-hexane is added to acetone, or preferably at least more than 30% of n-hexane is added to the extraction solvent, favorable results were obtained.

Further, extraction results were investigated by using other extraction solvents of organic solvent than the mixed solvent of n-hexane and acetate.

### Example 6

Recovery tests were conducted by adding 100 ppb of pesticides to agricultural products in the same procedure as in method 1 of the invention, except that n-hexane was used as the extraction solvent. Results are shown in Table 6.

### Example 7

Recovery tests were conducted in the same manner as in Example 6, except that benzene (logPow 2.13) was used as the extraction solvent. Results are shown in Table 6.

### Comparative Example 4

Recovery tests were conducted in the same manner as in Example 6, except that octane (logPow 5.0) was used as the extraction solvent. Results are shown in Table 6.

### Comparative Example 5

Recovery tests were conducted in the same manner as in Example 6, except that acetonitrile (logPow −0.3) was used as the extraction solvent. Results are shown in Table 6.

TABLE 6
Recovery rate by 100 ppb addition recovery test

| | Recovery rate | | | |
|---|---|---|---|---|
| | Example 6 | Example 7 | Comp. | Comp. |
| | n-hexane | benzene | Example 4 | Example 5 |
| Pesticide | 3.9 | 2.13 | octane 5.0 | acetonitrile −0.3 |

Pyrethroid compounds

| | | | | |
|---|---|---|---|---|
| Acrinathrin | 99.8 | 96.7 | 85.2 | X |
| Cyhalothrin 01 | 99.4 | 99.5 | 100.5 | X |
| Cyhalothrin 02 | 97.8 | 101.1 | 97.9 | X |
| Tefluthrin | 99.8 | 97 | 99.1 | 71.6 |
| Fenvalerate | 101.3 | 99.4 | 98.9 | 82.2 |
| Fenvalerate 02 | 92.2 | 90.1 | 91.0 | 79.5 |

Organic chlorine compounds

| | | | | |
|---|---|---|---|---|
| α-BHC | 75.6 | 95.2 | 60.1 | 75.6 |
| β-BHC | 88.2 | 93.3 | 55.1 | 80.5 |
| γ-BHC | 85.6 | 96.1 | 61.2 | 83.1 |
| δ-BHC | 88.4 | 97.3 | 64.5 | 79.5 |
| o.p.-DDT | 106.7 | 97.6 | 105.7 | 68.6 |
| p.p-DDT | 105.3 | 99.5 | 108.1 | 58.3 |
| Aldrin | 76.9 | 90.4 | 40.7 | 75.3 |
| Dieldrin | 96.1 | 93.2 | 97.1 | 83.2 |
| Endrin | 98.2 | 92.2 | 99.0 | X |

Nitrogen compounds

| | | | | |
|---|---|---|---|---|
| Isoprocarb | 91.1 | 91.1 | 80.1 | 88.1 |
| Ethiofencarb | 30.2 | 65.8 | 5.1 | 60.5 |
| Chlorpropham | 103.2 | 99.7 | 90.8 | 80.5 |
| Thiobencarb | 98.5 | 97.4 | 70.2 | 83.6 |
| Tebuconazole | 70.5 | 93.2 | 40.1 | 90.3 |
| Fenobucarb | 92.1 | 90.3 | 60.3 | 74.3 |
| Bendiocarb | 100.6 | 96 | 99.5 | X |
| Pendimethalin | 95.3 | 94.3 | 96.0 | 78.9 |
| Mepronil | 95.6 | 94.4 | 81.2 | 80.1 |
| Lenacil | 60.2 | 84.6 | 25.0 | 86.7 |

Organic phosphorus compounds

| | | | | |
|---|---|---|---|---|
| Acephate | 0.0 | 58.2 | 0.0 | 55.3 |
| Isofenphosoxon | 35.7 | 61.3 | 4.1 | 74.9 |
| Chlorpyrifos | 91.6 | 93.1 | 94.3 | X |
| Dichlorvos | 32.6 | 51.1 | 5.3 | X |
| Diazinon | 84.3 | 94.1 | 75.0 | X |
| Thiometon | 80.8 | 81.6 | 29.1 | 68.7 |
| Pyraclofos | 58.5 | 90.26 | 30.2 | 101.8 |
| Phosalone | 38.7 | 80.5 | 20.4 | 75.0 |
| Malathion | 95.3 | 92.5 | 59.4 | 86.2 |

X: not measurable due to pigments.

As shown in Table 6, it is revealed by comparison between Example 6 and 7 and comparative examples 4 and 5 that favorable results were not obtained in the extraction solvent using solvents of which logPow is out of range of 0 to 4, such as octane (logPow 5.0) or acetonitrile (logPow −0.3). On the other hand, by using solvents having logPow in a range of 0 to 4 such as n-hexane (logPow 3.9) or benzene (logPow 2.13), favorable extraction efficiency was recognized.

1. A method of extracting residual pesticides in agricultural products comprising the following steps:
(1) a step of processing agricultural products into a shape suitable for extraction of residual pesticides;
(2) a step of treating the processed agricultural products with a dehydrating agent; and
(3) a step of extracting residual pesticides from the dehydrated agricultural products, by using a hydrophobic solvent of octanol/water partition coefficient (logPow) of 0 to 4, or a mixed solvent of hydrophobic solvent and hydrophilic solvent.

2. The method of claim 1, wherein the mixed solvent of hydrophobic solvent and hydrophilic solvent is an n-hexane-acetone mixed solvent.

3. The method of claim 1 or 2, wherein a step of treating with active carbon and/or carrier for reversed-phase chromatography is carried out simultaneously with or after the step of treating with the dehydrating agent.

4. An extraction kit for extracting residual pesticides in agricultural products composed of a pretreatment agent mainly comprising a dehydrating agent, and an extraction agent of a hydrophobic solvent of octanol/water partition coefficient (logPow) of 0 to 4, or a mixed solvent of hydrophobic solvent and hydrophilic solvent.

5. The extraction kit of claim 4, wherein the mixed solvent of hydrophobic solvent and hydrophilic solvent is an n-hexane-acetone mixed solvent.

6. The extraction kit of claim 4 or 5, wherein the pretreatment agent contains, together with the dehydrating agent, at least one of active carbon and carrier for reversed-phase chromatography.
